(19) United States
(12) Patent Application Publication
(10) Pub. No.: US 2011/0099269 A1
(43) Pub. Date: Apr. 28, 2011

(54) MESSAGE FILTRATION IN A NETWORK MONITORING SYSTEM

(75) Inventor: Northon Rodrigues, Oregon City, OR (US)

(73) Assignee: Thomson Licensing Corporation

(21) Appl. No.: 12/737,153

(22) PCT Filed: Jun. 10, 2008
(86) PCT No.: PCT/US2008/007242

§ 371 Date: Dec. 10, 2010

(51) Int. Cl. G06F 15/173

(52) U.S. Cl. 709/224

(57) ABSTRACT

A system and method for monitoring unit for providing network monitoring and message filtration in a network system is provided including a message generator configured to generate at least one alert message for defining an alert condition in the network system. A message designator is provided for designating the at least one alert message in accordance with the state of the alert condition. A reset module is provided configured for generating a reset message for defining when an alert condition is resolved. The reset message is automatically mapped to or associated with its corresponding alert message, which is now designated as a resolved or inactive message. A user view is provided in which only unresolved or active messages are displayed.

### TECHNICAL FIELD

The present invention generally relates to network monitoring, and more particularly, to a system and method for reducing and preventing unnecessary messages from being displayed to a user in a network monitoring system.

### BACKGROUND

Monitoring systems, e.g., a network monitoring system, constantly monitor a computer network for slow or failing system components to ensure that the facility runs at optimal levels, and notify the administrator in case of problems in a facility such as email outages, power supply failures, slow network, or other alarm conditions in a facility. Network monitoring is a vital function in network management. Exemplary networks in which such monitoring might be desirable may include any type of computer network, such as Local Area Network (LAN).

Most monitoring systems contain logs listing messages detailing all the actions and functions of the network so that the network administrator can review it in case there are unexpected problems to determine the cause of those problems. However, when using monitoring systems, users are often faced with a barrage of messages, many of which are not meaningful, important or necessary, or are redundant. This can distract from, impede and sometimes hide the genuinely important messages outlining issues and problems which must be addressed.

Exemplary ways to handle this problem include simply reviewing all the messages as carefully as possible, which may become time-consuming and tedious, turning off broad categories of messages from being displayed, which might run the risk of the user not being alerted to a genuine problem in the system, or by extracting the messages into a spreadsheet for review and deleting unwanted messages to reduce the message set, which is also laborious and time-consuming. Accordingly, a system and method for efficiently reducing message clutter in a network monitoring system while maintaining effective monitoring of the network system, is highly desirable.

### SUMMARY

In one embodiment according to the present principles, a system and method is provided for reducing the number of messages displayed to a monitoring user in a network monitoring system while ensuring effective notification to a user of any problems/issues in the system in need of resolution. Thus, efficiency in system monitoring is improved, while unnecessary, redundant, superfluous messages or ‘message clutter’ is reduced or eliminated.

Such is achieved via the designation of one or more messages as being in an ‘active’ or ‘inactive’ state. An active message is a message that is alerting the user of a possible or potential problem situation. Once a problem situation is resolved, a reset message is generated and mapped to the message or message set associated with the specific problem. If a system does not provide a reset message, then the managing system preferably generates a “reset” event once the problem is resolved. The message or set of messages which were associated with the specific problem situation are then designated as being ‘inactive.’ Preferably, only the ‘active’ messages are displayed to the user for review during monitoring.

In one aspect of the present principles, a monitoring unit for providing network monitoring and message filtration in a network system is provided comprising a message generator configured for generating at least one alert message for defining an alert condition in the network system, a message designator configured for designating the at least one alert message in accordance with the state of the alert condition, and a reset module configured for generating a reset message defining when an alert condition is resolved and for mapping the reset message to its corresponding one alert message.

According to another aspect, a system for providing network monitoring and message filtration in a network is provided comprising at least one network device and at least one monitoring device connected to the network, said monitoring device further comprising a monitoring module comprising a message generator configured for generating at least one alert message for defining an alert condition in the network system, a message designator configured for designating the at least one alert message in accordance with the state of the alert condition, and a reset module configured for generating a reset message defining when an alert condition is resolved and for mapping the reset message to its corresponding at least one alert message.

According to yet another aspect, a method for providing monitoring and message filtration in a network is provided comprising the steps of generating at least one alert message for an alert condition, and designating the at least one alert message in accordance with a state of the alert condition, wherein when the alert condition is resolved, further comprising the steps of removing the alert messages corresponding to the resolved alert condition from a first user view and providing only unresolved alert messages on the first user view.

These and other aspects, features and advantages of the present principles will be described or become apparent from the following detailed description of the preferred embodiments, which is to be read in connection with the accompanying drawings.

### BRIEF DESCRIPTION OF THE DRAWINGS

In the drawings, wherein like reference numerals denote similar elements throughout the views:

FIG. 1 is an exemplary message mapping system configuration showing the relationship and association between alert messages, a main alert message and a reset message according to one aspect of the present principles;

FIG. 2 shows exemplary layouts depicting one-to-one and a plurality-to-one alert to reset message mapping according to an aspect of the present principles;

FIG. 3 is a block diagram of an exemplary network monitoring system setup according to an aspect of the present principles;

FIG. 4 is a flow diagram of an exemplary method for reducing excess messages in a network monitoring system according to an aspect of the present principles;

FIG. 5 is an exemplary illustration of a user view listing the messages displayed by a network monitoring system; and

FIG. 6 is an exemplary illustration of a user view listing the messages displayed by a network monitoring system according to an aspect of the present principles.

It should be understood that the drawings are for purposes of illustrating the concepts of the present principles and are not necessarily the only possible configurations for illustrating the present principles.

### DETAILED DESCRIPTION

A method, apparatus and system for reducing message clutter in a monitoring system is advantageously provided according to various aspects of the present principles. Although the present principles will be described primarily within the context of a network monitoring system and method, the specific embodiments of the present principles should not be treated as limiting the scope of the invention. It will be appreciated by those skilled in the art and informed by the teachings of the present principles that the concepts of the present principles can be advantageously applied in any other environment in which a computer-related monitoring function is desired.

Exemplary definitions for terms used in this disclosure are as follows:

Alert message: any message generated by, e.g., a software or hardware module that alerts the user of a possible malfunction. E.g., these messages can be categorized as, e.g., emergency alarms, critical alarms, warnings or information.

Reset: any message generated by, e.g., a software or hardware module or by a user that indicates that a specific alert condition has been resolved

One to one Alert to Reset mapping: one alert message is mapped to, or associated with, one reset message

Plurality-to-one Alert to Reset mapping: a plurality of alert messages are mapped to, or associated with, one reset message.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that any block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which can be substantially represented in computer readable media and so executed by a computer or processor, whether or not such computer or processor is explicitly shown.

Advantageously, according to one aspect of the present principles, a system and method for reducing message clutter in a network monitoring system with improved efficiency and accuracy is heretofore provided. The system and method according to the present principles can advantageously be incorporated and utilized in any network in need of monitoring actions, such as e.g., performance or security monitoring.

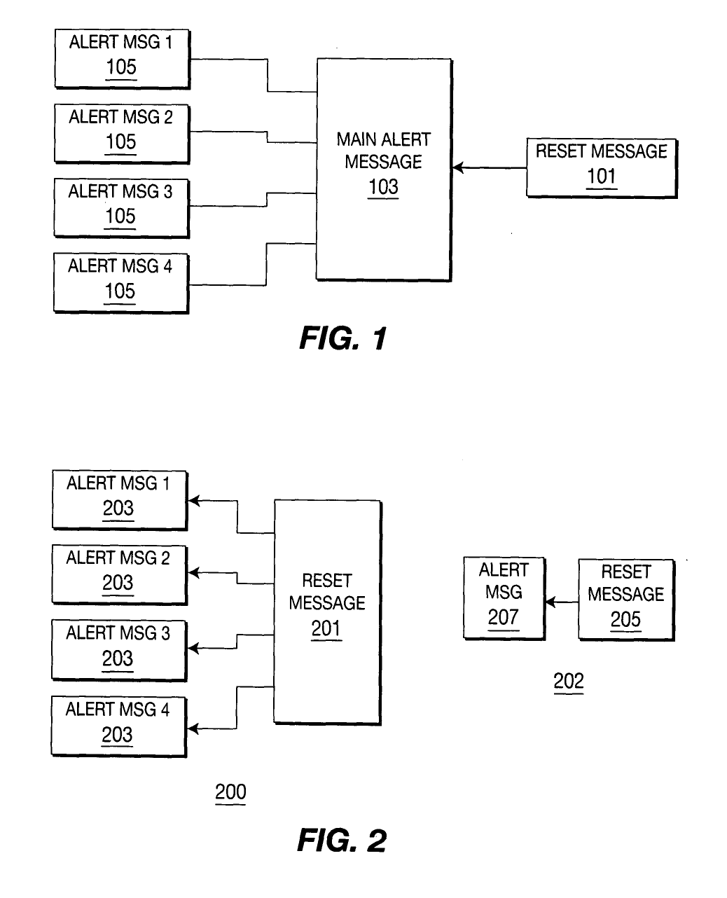

Referring now to the Figures, an exemplary message mapping system configuration showing the relationship and association between alert messages, a main alert message and a reset message according to an aspect of the present principles is shown in FIG. 1. As can be seen, in one example a hierarchical format can be employed wherein a plurality of “alert” messages 105, e.g., relating to or embodying a specific problem can be mapped or assigned to a main alert message 103. The main alert message 103 can summarize or embody a specific issue, under which the plurality of alert messages 105 can be categorized under or related to. Another way of viewing this is that a main alert message 103 can be linked to a group of corresponding alert messages 105. Once this association has been created, a single reset message 101 can be used to reset, not only the main alert message 103, but subsequently, the plurality of alert messages 105.

Alert messages can comprise, e.g., critical alarms, warnings, errors, etc. informing the user of malfunctions or problems in the network. In addition to ‘alert’ messages, ‘status’ messages regarding network monitoring can be provided which include status updates and the like with respect to various devices being monitored. An exemplary listing of network monitoring messages (which can include status messages/alert messages) can comprise, e.g., “Authentication failure,” “System reboot,” “Device Offline,” “Network Latency Slow,” “Network Latency Normal,” “Transfer system fault,” etc.

FIG. 2 shows exemplary layouts depicting one-to-one 202 and plurality-to-one 200 alert message to reset message mapping according to an aspect of the present principles. As described above, a “Reset” message comprises any message generated by a software or hardware module, or even by a user that signifies that a specific alert condition has been resolved. In a plurality-to-one mapping 200, a number of alert messages 203 are associated with a single Reset message 201, wherein in one-to-one mapping 202, a single alert message 207 is associated with a single Reset message 205.

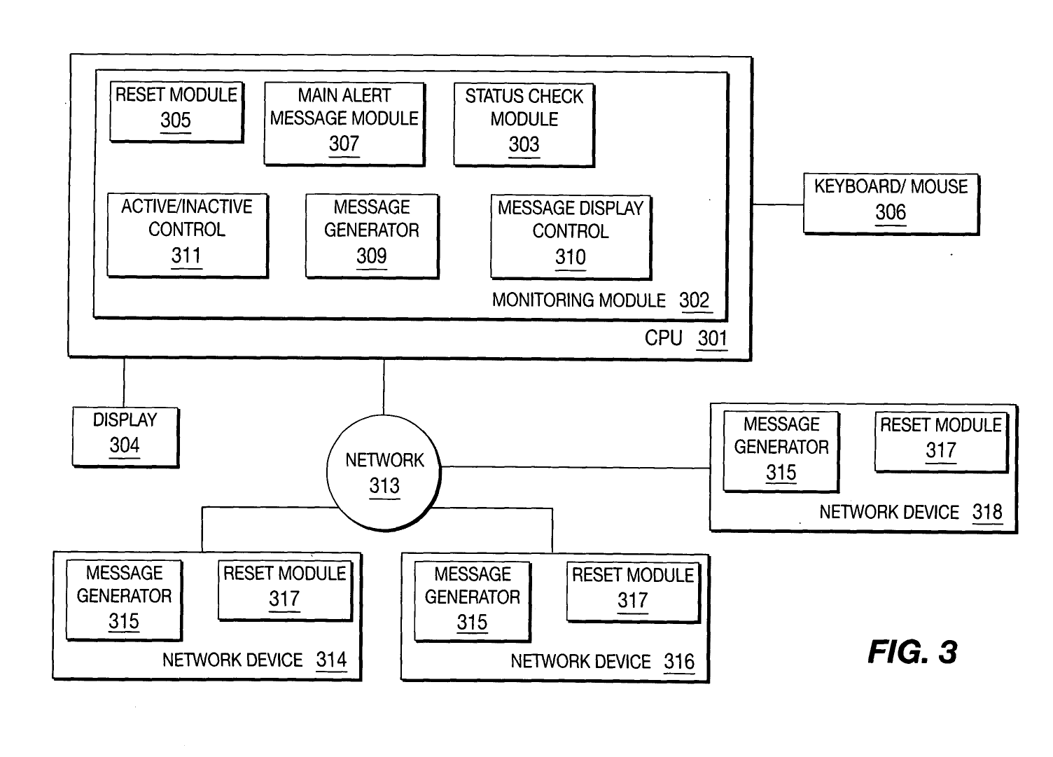

FIG. 3 is a block diagram of an exemplary network monitoring system setup according to an aspect of the present principles. A monitoring device, e.g., embodied in a CPU (central processing unit) 301 can be provided, e.g., as the central unit in a computer having the logic circuitry that performs the instructions of a computer's programs. The monitoring device/CPU 301 preferably is connected to a display 304 and keyboard/mouse 306, and includes a monitoring module or unit 302 according to an aspect of the present principles configured for performing network monitoring and message reduction functions.

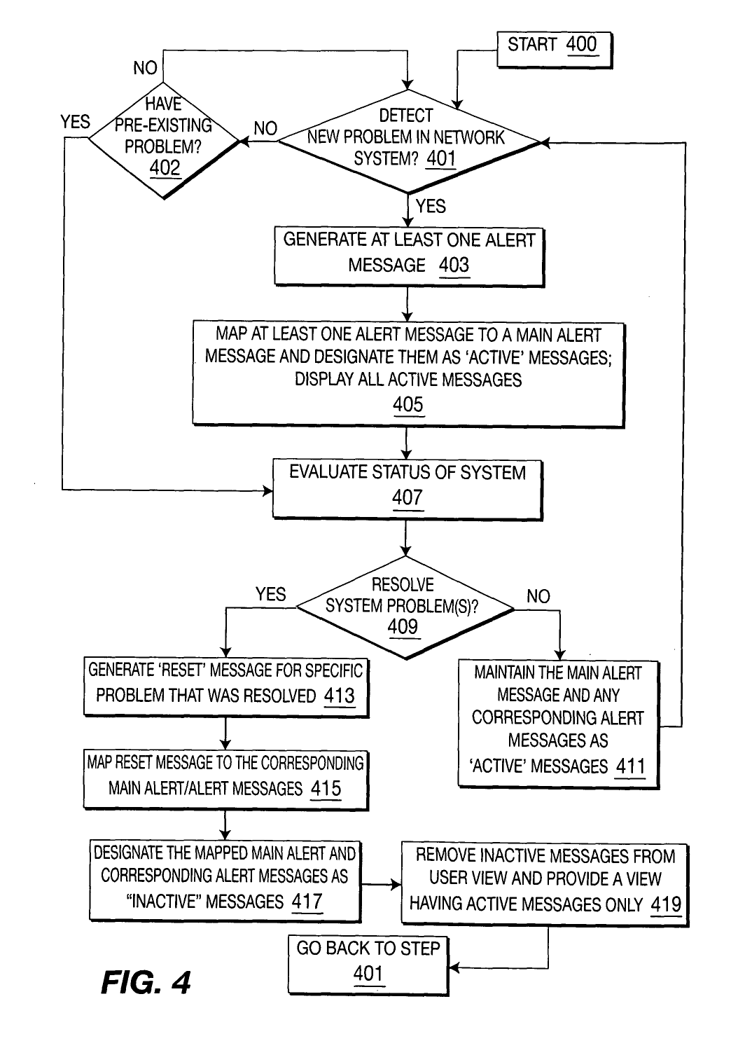

The monitoring module 302 preferably includes a reset module 305, a main alert message module 307, an active/inactive control 311, a message generator 309, a status check module 303 and a message display control 310, and is configured to communicate with a variety of network devices 314, 316, 318 via a network 313. The network 313 can comprise, e.g., any type of computer network, such as a local area network (LAN). Generally, the monitoring module 302 is configured to monitor, detect, report and filter events and network system activity. The functions of the various components of the monitoring module 302 will be further discussed with respect to FIG. 4 below.

Advantageously, the monitoring module 302 automatically associates or maps a reset message (indicating a resolved problem) with the alert messages which embodied or were related to the corresponding problem/alert condition that is now resolved. The monitoring module 302 provides for the designation of messages in accordance with a state of the alert condition, that is, as being in an ‘active’ state (denoting a current unresolved problem) or an ‘inactive’ state (denoting a resolved or immaterial problem).

Preferably, the system enables the ability for only active messages to be actually displayed to the user on a user view (e.g., in a ‘first’ user view). This view of ‘active messages only’ significantly reduces the overall number of messages which a user must review, since the user will no longer need to spend time reading or sifting through messages pertaining to matters which can have already been resolved. Alternate user views (e.g., ‘second’ and ‘third’ views) can be provided, such as views depicting ‘Inactive’ messages only, or ‘All’ messages (both active and inactive). The different user views can be displayed upon user request.

Each network device 314, 316, 318 that is being monitored can itself optionally include a message generator 315 and/or a reset module 317 for independently notifying and updating the monitoring module 302 of its current status and events, and/or of specific problems which have been resolved, respectively. Also, as discussed above, the monitoring module 302 can also generate reset messages if a device or software module does not have that functionality.

FIG. 4 is a flow diagram of an exemplary method for reducing excess messages in a network monitoring system according to an aspect of the present principles. For explanatory purposes, the steps of FIG. 4 is discussed in view of the system of FIG. 3.

In step 401, it is determined whether there is a problem (i.e., a ‘new’ or previously undetected problem) in the network system, such as a performance problem. This determination can be performed by the status check module 303. If a problem is detected (e.g., an error, malfunction, etc.), at least one alert message is generated (step 403) which describes and alerts the user of a possible malfunction in the system. This can be performed by message generator 309. It is noted that multiple alert messages can be generated for each specific problem or malfunction.

According to one embodiment, a main alert message can be created (e.g., generally describing a certain type of issue or problem), and all alert messages pertaining to each particular problem can be automatically mapped to their respective main alert messages (step 405). The main alert message can be created by the main alert message module 307 and/or the message generator 309. The creation of a main alert message is optional, however, and alternatively, one or more alert messages can be evaluated and processed without being mapped to a main alert message.

Any or all the individual alert messages, as well as the main alert messages, can be designated as “active” or “inactive” messages, e.g., by an active/inactive control 311. Here, in step 405 a newly created alert message is typically designated as an ‘active’ message and all active messages can be displayed to the user on display 304 (e.g., via message display control 310).

In step 407 the status of the system is evaluated (e.g., by status check module 303), and in step 409 it is ascertained whether any or all of the detected system or network problems have been resolved. If no, the main alert message (if any) and all its corresponding alert messages are maintained as having the ‘active’ message designation and the process returns to step 401. If yes, a “Reset” message pertinent to the specific problem that has now been resolved is generated (step 413). The Reset message, as described above, can comprise any message automatically generated by a software or hardware module (e.g., by Reset module 305) or manually by a user (e.g., via manual deployment and use of the reset module 305). That is, the user can manually create a Reset message (cause a Reset condition), when the user determines that a certain problem is deemed resolved. Alternatively, the user can provide a set of rules which outline when a problem is considered resolved. Thus, a user can customize when a reset condition exists and when a particular problem is considered resolved.

It is noted that in one alternate embodiment, network devices which are connected to the network and are being monitored can each include their own modules and controls, e.g., a message generator 315 and/or reset module 317, and thus possess at least independent alert message and/or Reset message generation capabilities. Each network device can further include additional and/or alternate modules and controls for communicating with CPU 301.

In step 415, the Reset message is mapped or associated with its corresponding main alert and/or alert messages describing or related to the problem which has now been resolved. The mapping can be performed automatically via the Reset module 305 or manually by the user. The Reset message can be mapped to one or a plurality of main alert and/or alert messages.

In step 417, the main alert and corresponding alert messages which were associated with a Reset message are designated as “inactive” messages (via the active/inactive control 311). The messages deemed “inactive” (i.e., those that refer to problems which have been resolved) are preferably automatically removed from at least one of the user views, and a user view showing only active (i.e., “unresolved”) messages is provided (step 419). This advantageously provides at least one view to the user in which the overall number of messages displayed to the user constitutes those which are alerting the user to actual, current unresolved problems. The process then returns to step 401.

It is noted that in step 401, if there is no new problem detected in the network system, it is determined whether a pre-existing problem exists (step 402). If no, the process loops back to step 401, so as to provide continuous surveillance of the facility/system. If a pre-existing problem does exist, the process proceeds to step 407, in which the current status of the system is evaluated, i.e., to see which, if any, of the problems have been resolved. The process continues on as explained above, i.e., from steps 409 onward.

The system can further provide the user with other views, such as an option to view all “inactive” messages if desired. For example, the user can be prompted to select from a plurality of different views, such as “Active messages only,” “Inactive messages only,” “All messages,” etc.

An example follows:

In the case of a temperature monitoring system, a series of alert messages can be provided for alerting the user of various fluctuations in temperature during a time period, or if temperature falls below a certain value. Each of these individual alert messages can be categorized or mapped under a main alert message, which can be designated as: “Temperature Alert.” To illustrate:

Given the following set of rules:

Desired/normal temperature of device=<100° C.

Warning zone: 100-110° C.

Critical zone: >110° C.

Time (minutes)

| 1 | 2 | 3 | 4 | 5 . . . etc. |
|---|---|---|---|---|
| 105° C. | 106° C. | 112° C. | 95° C. | 90° C. |

At times 1-5, the following messages can be issued for the device with respect to its monitored temperature:

1) Warning alert
2) Warning alert

### 3) Critical Alert

4) temperature normal—problem resolved, Reset message issued
5) normal

In the above example, the main alert message can comprise “Temperature Alert” whereas the messages 1-3 can comprise the alert messages which correspond to the main alert. Once the problem is resolved, a Reset message can be issued, and all the alert messages 1-3 can simultaneously be rendered ‘inactive.’

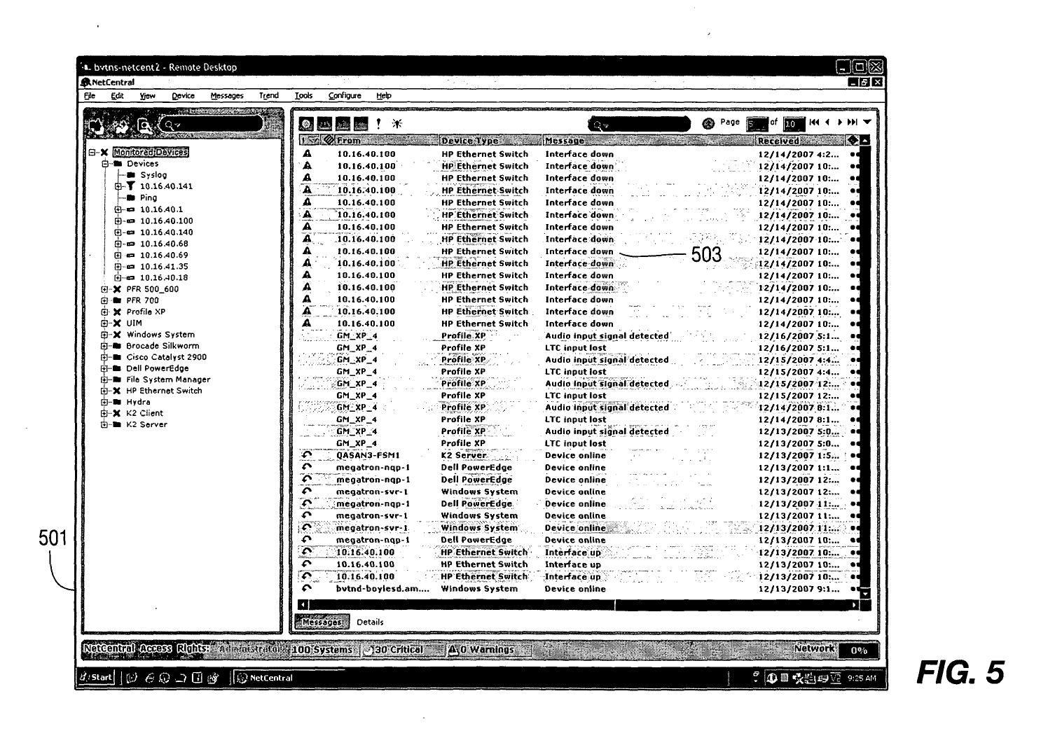

In FIG. 5, an exemplary user view 501 is shown depicting a listing of network monitoring messages 503 which can be displayed to the user on a graphical user interface. Such messages 503 can be arranged to be listed in order of date received, the device from which they were received, the type of message, etc. according to the user's preferences. Typically, there are a large number of messages displayed to the user at any one time informing the user of the status of, and events occurring for, the various components and devices being monitored on the network system. A listing of monitored devices can be shown in the user view 501. Here for example, 47 pages of messages are displayed to the user in a user view under the “Message Viewer” screen.

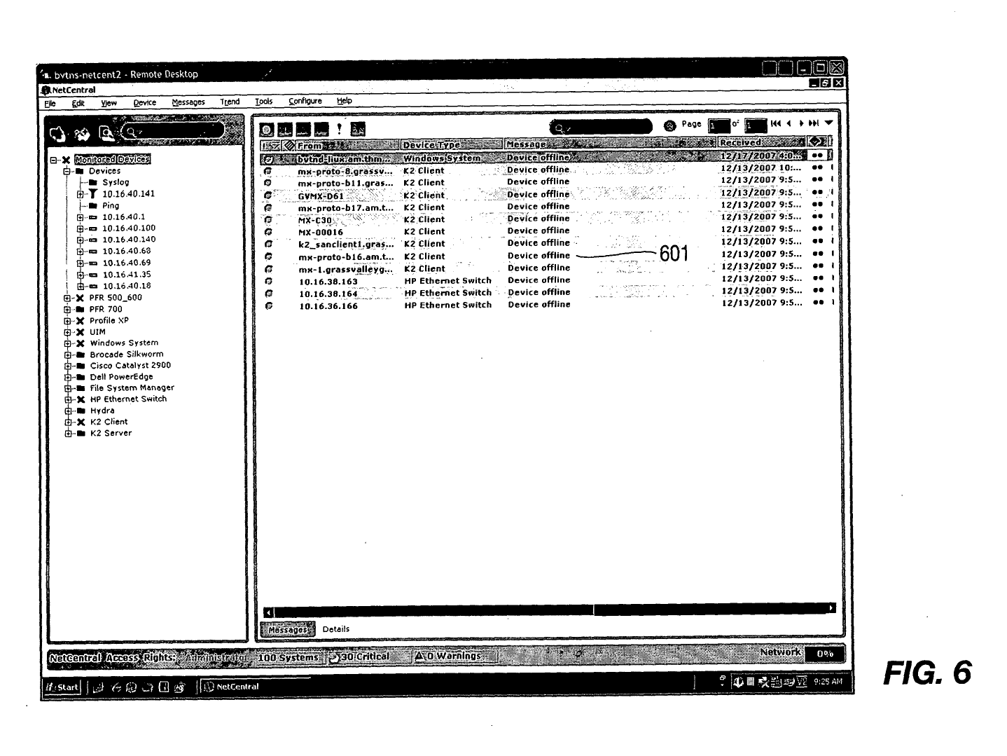

FIG. 6 depicts an exemplary listing of messages 601 displayed to the user after the active message filtering according to an aspect of the present invention is applied. In this example, only 1 page of messages comprising “active” messages is now displayed in the “Message Viewer” screen. This represents a tremendous reduction in the number of messages presented to the user for viewing.

Although the embodiment which incorporates the teachings of the present principles has been shown and described in detail herein, those skilled in the art can readily devise many other varied embodiments that still incorporate these teachings. Having described preferred embodiments for a system and method for facility monitoring (which are intended to be illustrative and not limiting), it is noted that modifications and variations can be made by persons skilled in the art in light of the above teachings. It is therefore to be understood that changes can be made in the particular embodiments of the present principles disclosed which are within the scope and spirit of the present principles as outlined by the appended claims. Having thus described the present principles with the details and particularity required by the patent laws, what is claimed and desired protected by Letters Patent is set forth in the appended claims.

1. A system, comprising:
a message generator configured to generate at least one alert message to define an alert condition in a network system;
a message designator configured to designate the alert message in accordance with a state of the alert condition; and
a reset module configured to generate a reset message when an alert condition is resolved and to map the reset message to its corresponding alert message.

2. The system of claim 1, further comprising:
a main alert message module configured to create at least one main alert message encompassing at least one alert message.

3. The system of claim 2, wherein the alert message is mapped to at least one main alert message.

4. The system of claim 1, further comprising:
a message display control configured to display a user view for the alert message in accordance with the state of the alert condition.

5. The system of claim 4, wherein the state of the alert condition comprises one of an active state when the alert condition is unresolved and an inactive state when the alert condition is resolved.

6. The system of claim 5, wherein when the alert condition is resolved, its corresponding alert message(s) mapped with the reset message is removed from the user view.

7. The system of claim 5, wherein the message display control is configured to display only active messages in accordance with a first user view.

8. A system, comprising:
at least one network device and at least one monitoring device connected to the network, said monitoring device further comprising:
a monitoring module comprising a message generator configured to generate at least one alert message for defining an alert condition in the network system;
a message designator configured to designate the alert message in accordance with a state of the alert condition; and
a reset module configured to generate a reset message defining when an alert condition is resolved and to map the reset message to its corresponding at least one alert message.

9. The system of claim 8, further comprising:
a main alert message module configured to create at least one main alert message encompassing at least one alert message.

10. The system of claim 9, wherein the at least one alert message is mapped to at least one main alert message.

11. The system of claim 9, further comprising:
a message display control configured to display to a user the alert message in accordance with the state of the alert condition.

12. The system of claim 11, wherein said state of the alert condition comprises one of an active state when the alert condition is unresolved and an inactive state when the alert condition is resolved.

13. The system of claim 12, wherein when the alert condition is resolved, its corresponding alert message mapped to the reset message is removed from an active message user view.

14. The system of claim 12, wherein the message display control is configured to display at least one of all active messages, all inactive messages, and all active and inactive messages in separate user views.

15. A method, comprising the steps of:
generating at least one alert message for an alert condition; and
designating the alert message in accordance with a state of the alert condition, wherein when the alert condition is resolved, further comprising the steps of:
removing the alert messages corresponding to the resolved alert condition from a user view; and
providing only unresolved alert messages on the user view.

16. The method of claim 15, further comprising the step of:
mapping the at least one alert message to a main alert message.

17. The method of claim 16, further comprising the step of:
removing from the user view the at least one alert message corresponding to the main alert message when the alert condition is resolved.

18. The method of claim 15, wherein when the alert condition is resolved, further comprising the step of:
generating a reset message for the specific alert condition resolved.

19. The method of claim 18, further comprising the step of:
automatically mapping the reset message to the alert message corresponding to the resolved alert condition.

20. The method of claim 15, wherein the state of the alert condition comprises one of an active state when the alert condition is unresolved, and an inactive state when the alert condition is resolved.
